(19) United States
(12) Patent Application Publication
(10) Pub. No.: US 2010/0235909 A1
(43) Pub. Date: Sep. 16, 2010

(54) System and Method for Detection of a Change in Behavior in the Use of a Website Through Vector Velocity Analysis

(75) Inventors: Mike Eynon, Mountain View, CA (US); Laura Mather, Mountain View, CA (US); Erik Westland, Carlisle, MA (US); Jim Lloyd, San Francisco, CA (US)

Correspondence Address: BUCHANAN, INGERSOLL & ROONEY PC, POST OFFICE BOX 1404, ALEXANDRIA, VA, 22313-1404, US

(73) Assignee: Silver Tail Systems, Palo Alto, CA (US)

(21) Appl. No.: 12/404,163

(22) Filed: Mar. 13, 2009

(51) Int. Cl. G06F 21/00

(52) U.S. Cl. 726/22

(57) ABSTRACT

A system and software for identifying the change of user behavior on a website includes analyzing the actions of users on a website comprising a plurality of fields or input parameters that identify the actions performed on a website including fields related to previous actions by that user or other users of the website. The fields or input parameters are represented in a vector format where vectors represent different sessions of activity on the website, pages of the website, users of the website, or other attributes of the use of a website. Analysis is performed to determine if new sessions are similar or dissimilar to previously known sessions and if a session is converging or diverging from known sessions based on the velocity and direction of the velocity of the vectors in the vector space.

### BACKGROUND

1. Field of the Invention

The present invention relates to computer systems and methods for detecting new uses of legitimate business flows of websites. It is important for websites to understand the new ways users are using their sites since this can help identify both new legitimate and malicious uses of a website.

2. Background Information

In 2005, 75% of all fraud perpetrated through the internet was initiated through websites and only 25% of online fraud was initiated through email. Because of the success of technologies like firewalls, intrusion prevention systems, and web application security, bad guys are finding more sophisticated ways to steal money and victimize internet users and the owners of websites.

There are many ways criminals can use websites to victimize users or the owners of the websites. Some of these fraud types include stealing money using stolen passwords, selling merchandise that will not be delivered, paying for merchandise with illicit funds (either stolen funds or through fraudulent payment mechanisms like fake cashier's checks), false offers of money (also known as Nigerian scams), soliciting accomplices to do things like receive illicit funds or illicit goods and pass them along to the scammer, spam users with nuisance messages, deliver email or other messages that contain malicious code, etc.

In the past, many of these fraud types were perpetrated by trying to “break in” to the systems or intranets of the targeted companies. By finding holes in VPNs (Virtual Private Network), firewalls, or databases, fraudsters could steal money or credentials to perpetrate their fraud. Because intrusion protection products have become much more powerful, fraudsters have had to find other ways to make their profits. The next step in the progression was to find bugs in a website's code and use those bugs to perform the illicit activity. Web application security vendors now check website code to find code vulnerabilities that allow fraudsters access to sensitive information so that these vulnerabilities can be addressed.

Because web application security finds the code vulnerabilities on websites, fraudsters have turned to an even more sophisticated methodology for exploiting websites and the users of those websites. Business logic abuse is defined as the abuse of legitimate pages of a website to perpetrate fraud and other illicit behaviors. A simple example of business logic abuse is guessing passwords to steal accounts on websites. By testing passwords on the signin page of a website, the fraudster is using a legitimate website business flow—the signin function—to perpetrate bad activity. Other examples of malicious use of websites through legitimate business flows include the mass registration of accounts (for example to send spam on social network sites or to game incentive programs on financial institution or e-commerce sites), scraping of email addresses and personal information off of social network sites, scraping of financial and personal information off of financial institution websites.

New website behaviors are not always fraudulent. There are cases where website owners want to change the behaviors of users on their site. An example is a website that launches a new feature—that website wants its users to take advantage of the new feature, thereby changing the way the users use the website. Another example is when a particular feature of a website becomes popular because of news coverage. Website owners want to know when new behaviors are occurring on their websites so they can track adoption of features, understand the usage of their site, or determine fraudulent events on their site.

### SUMMARY OF THE INVENTION

A behavior change detection system is configured to detect changing user behaviors on a website by mapping website session information into numerical vectors and using the vector spaces associated with those vectors to track the changes in website session behaviors. The velocity of movement of a vector for a particular session, user, etc. and the exemplar of a normal session, user, etc. is analyzed to determine how close the actions of the current session, user, etc. is to expected behavior. As the distance from the exemplar vector increases, the likelihood the behavior is a new behavior also increases. As thresholds are met that indicate a session vector has deviated enough from the exemplar to indicate new behavior, appropriate actions can be taken to better understand and respond to that behavior.

In one aspect, historical vectors are used to determine the exemplar session vectors for a website. All or a subset of historical vectors can be used.

Finally, the direction of movement and velocity of a vector towards or away from other vectors in the vector space is determined. This velocity and direction is used to detect when a vector is anomalous compared to other vectors in the space.

In accordance with another aspect, a method for determining a likelihood of a previously unknown use of a website using a computer system that processes data from a website session into a plurality of parameters configured to represent website session information, and wherein the parameters are combined into a vector in a vector space, the method comprises: mapping the vector into various vector spaces; modifying the vector as new information about each session is obtained; comparing a change in position of the vector in the various vector spaces to determine the direction in which the vector is moving with respect to an exemplar vector in a same or a similar vector space; generating a score indicative of the similarity between the vector and the exemplar vector in the same or the similar vector space; and returning the score to an investigation system for analysis. In this case, an exemplar vector is a vector that represents the overall behavior of the entities. It could be represented by an average or derived using other methodologies to determine exemplars. The exemplar vector may take into account all actions, users, or pages, or may only consider a subset of those entities.

In accordance with an aspect, a method for determining a likelihood of a previously unknown use of a website associated with a website session, comprises: receiving a plurality of parameters associated with an action performed during a website session; creating a session vector that has a dimension corresponding to each of the plurality of parameters associated with the action performed during the website session; modifying the session vector as new information about each website session is obtained; and comparing a change in position of the session vector in various vector spaces to determine the direction in which the session vector is moving with respect to an exemplar vector in a same or a similar vector space.

In accordance with another aspect, a method of mapping website session data into a vector space comprises: parsing session data into a plurality of parameters; mapping the parameters into n-dimensional vectors, wherein n is the number of parameters available about the action on the website, and wherein each vector is mapped into the n-dimensional space associated with the dimensions of the actions on the website; and comparing a change in position of each of the n-dimension vectors in various vector spaces to determine the direction in which each of the n-dimensional vectors is moving with respect to an exemplar vector in the various vector spaces.

In accordance with a further aspect, a behavior change detection system comprises: a website data center, which receives input parameters associated with website actions; and a behavior change detection center configured to detect behavior changes by users of a website based on: receiving a plurality of parameters associated with an action performed during a website session; creating a session vector that has a dimension corresponding to each of the plurality of parameters associated with the action performed during the website session; modifying the session vector as new information about each website session is obtained; and comparing a change in position of the session vector in various vector spaces to determine the direction in which the session vector is moving with respect to an exemplar vector in a same or a similar vector space.

In accordance with another aspect, a computer readable medium containing a computer program for determining a likelihood of a previously unknown use of a website associated with a website session, wherein the computer program comprises executable instructions for: receiving a plurality of parameters associated with an action performed during a website session; creating a session vector that has a dimension corresponding to each of the plurality of parameters associated with the action performed during the website session; modifying the session vector as new information about each website session is obtained; and comparing a change in position of the session vector in various vector spaces to determine the direction in which the session vector is moving with respect to an exemplar vector in a same or a similar vector space.

These and other features, aspects, and embodiments of the invention are described below in the section entitled “Detailed Description.”

### BRIEF DESCRIPTION OF THE DRAWINGS

For a better understanding of the nature of the features of the invention, reference should be made to the following detailed description taken in conjunction with the accompanying drawings, in which:

FIG. 1 illustrates a system for detecting changes to behavior on websites which includes the data center for a website and software for processing the website session data to detect behavior changes;

FIG. 2 illustrates a system for detecting changes to behavior on websites which includes a computing environment for a website and software for processing the website session data to detect behavior changes outside of the website's data center environment;

FIG. 3 illustratively represents a model data flow representative of the processing of website session data to detect behavior changes on a website as part of the behavior detection system of FIG. 1;

FIG. 4 illustrates a simplified diagram of session data mapped into a vector space, and wherein the vector space is represented in two dimensions;

FIG. 5 illustrates a simplified diagram of finding the distance between a vector associated with a particular session with the exemplar vector corresponding to the particular action;

FIG. 6 illustrates a simplified diagram of determining whether a particular session vector is moving towards or away from the exemplar session vector and at what velocity it is moving towards or away from the exemplar as new actions occur on the website associated with that particular session vector; and

FIG. 7 illustrates a simplified diagram of using the distance between a vector associated with a particular action on a website and the vector associated with the exemplar session associated with that action as well as the direction and velocity of the particular vector as compared to the exemplar vector to compute a score for whether the particular vector represents a behavior change.

### DETAILED DESCRIPTION OF THE INVENTION

The present invention is directed to a system and method for determining when user behavior on a website changes. In an exemplary embodiment of the invention, website behavior change is detected using feature vectors mapped into vector spaces and comparing the movement of a particular vector with the placement and movement of other vectors in those spaces to determine anomalous behavior versus typical behavior. Mapping website behavior into vector spaces provides a generalized methodology for building a multi-dimensional representation of user actions on a website. This generalized methodology allows the comparison of the current user, page view, or action on a website with what is known as a exemplar user, page view, or action on a website. By comparing the velocity and direction of movement in a vector space between the known typical behavior and the current behavior, decisions can be made as to whether the current behavior deviates in a meaningful way from typical behavior. In the case the current behavior deviates in a meaningful way from typical behavior, alerts can be issued to the appropriate parties.

In accordance with one exemplary embodiment of the invention, as additional actions of a user are recorded, the vector is updated and the vector's position in the vector space changes. As the vector's position in the vector space changes, the direction and velocity of the movement of the vector can be recorded and compared with its relative position and direction either towards or away from the exemplar vector for the current action. These techniques have proven to be efficient and effective even though the number of possible useful features of given vector spaces will generally be large.

The inventive system operates upon an incoming stream of input data generated by actions on a website. Example actions on a website generally correspond to clicks by the user of the website. These clicks can be done by a human or by an automated computer program. Automated computer programs can work by simulating website clicks or by working through the application programming interface of the website.

Examples of actions taken on websites include clicks to go to other pages of the websites and entering data into forms on the website. Examples of entering data into forms on a website include entering a user name and password on a website to sign-in to the website, filling out an email form to send email to another user of the website, or entering personal information to register for an account on the website.

As described in further detail below, each website action consists of multiple parameters as defined by any information corresponding to the action on the website that can be seen by the processors and computers related to a web server, a firewall, or other device that processes website traffic and additional information provided by the website or third parties. Examples of parameters associated with website actions include IP addresses, including those of any proxies used in the process of sending traffic to the website, browser header information, operating system information, information about other programs installed on the user's machine, information about the clock and other settings on the user's machine, cookies, referring URLs, usernames, text entered into website forms, and any other information associated with the user's action on the website. Examples of information provided by the website include the length of time the username has been registered, account numbers associated with the username, account balances associated with the username, previous actions performed by the cookie, etc. Examples of data provided by third parties include fraud probabilities associated with internet protocol addresses, geo-location information associated with internet protocol addresses, frequency scores associated with passwords, etc. Any other information that can be seen by the web server, firewall, etc. can be used in this model to map the current action into the vector space.

It can be appreciated that as each new action on the website occurs, the parameters associated with that action are mapped into several vector spaces. Examples of typical vector spaces include a vector space associated with a user, a vector space associated with a particular page, a vector space associated with a particular referring URL, etc.

Mapping the parameters associated with an action on a website into vector form means creating a vector that has a dimension corresponding to each of the parameters associated with an action on the website. As an action is processed, the web server, firewall, or other transaction processing device receives the information about the action on the website. The inventive system takes the information associated with the action on the website, parses out the specific data associated with each parameter of the action, creates a numerical representative of that data element, and puts that representative of the data element into its corresponding position in the associated vector. The representatives of the data elements are numerical values. In the case a parameter associated with an action is not a numerical value, that parameter is mapped to a numerical value using a hash function or lookup table.

As new actions are fed into the system, the vectors corresponding to those actions are updated with the new parameters associated with that action. For example, when looking at a particular website user, as specified by a userID, cookie, or other value, a sequence of actions on a website is called a user's session. The present invention looks at all of the actions in a particular session to determine if the current session is similar or different to the other sessions on the website, other sessions that use a particular website page, etc. In real-time, or in a batch processing mode that operates on timed increments, for example once an hour, the vectors for each action are computed. In addition, an exemplar vector for users, each page on the website, each referring URL, etc. are created.

To determine new website behavior, several factors are taken into consideration. First, each individual vector is compared against the exemplar vector in the corresponding vector space. Next, multiple actions by a user, on a particular page, with a particular referring URL, etc. are compared to determine if the individual vector associated with that entity is moving towards or away from the exemplar vector in the corresponding vector space. Finally, the velocity of the movement of the individual vector towards or away from the exemplar vector in the vector space can be determined. All three of these elements, the distance, velocity and direction of the velocity of the individual vector, are combined to create a score that is used to determine if the individual vector deviates from the exemplar vector in a meaningful way. If the generated score indicates the individual vector deviates from the exemplar vector in a meaningful way, the appropriate action is taken. Some appropriate actions to take include sending alerts to various website fraud detection systems, sending emails to interested parties, etc.

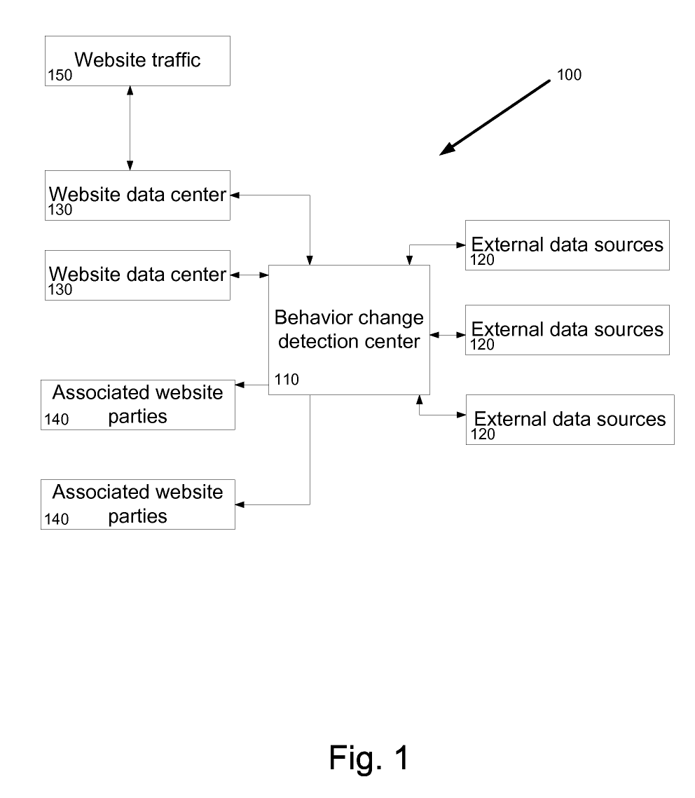

Turning now to FIG. 1, a behavior change detection system 100 includes a behavior change detection center 110 configured to detect behavior changes by the users of a website in accordance with the present invention. The behavior change detection center 110 may utilize data about the actions on a website provided by various external data sources 120 as well as data provided by the website's data center 130 which receives website traffic 150 of the type described below in connection with processing input parameters associated with website actions. In accordance with an exemplary embodiment of the invention, the website's data center 130 provides the information associated with the action performed on the website. As mentioned above, a notification is provided to the appropriate parties including those at the website's data center 130 or other associated website parties 140 in response to any detected behavior change. In exemplary embodiments the behavior change detection center 110 is capable of determining whether or not a website action constitutes a behavior change on a website in substantially real-time.

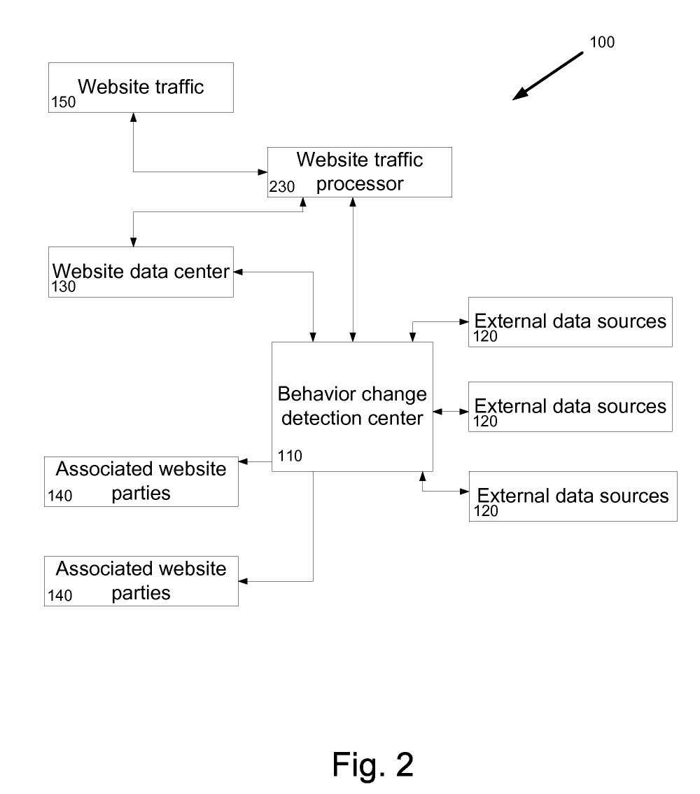

Referring to FIG. 2, a behavior change detection system 100 includes a behavior change detection center 110 configured to detect behavior changes by the users of a website in accordance with the present invention. The behavior change detection center 110 may utilize data about the actions on a website provided by various external data sources 120, data from the website's data center 130, and website traffic processor outside of the website's data center 230 of the type described below in connection with processing input parameters associated with website actions. Examples of places where traffic is processed outside of a website's data center environment include cloud computing, utility computing and software as service models. In this embodiment of the invention, website traffic processor outside of the website's data center 230 provides the information associated with the action performed on the website. As mentioned above, a notification is provided to the appropriate parties including those at the website's data center 130 or other associated website parties 140 in response to any detected behavior change. In exemplary embodiments the behavior change detection center 110 is capable of determining whether or not a website action constitutes a behavior change on a website in substantially real-time.

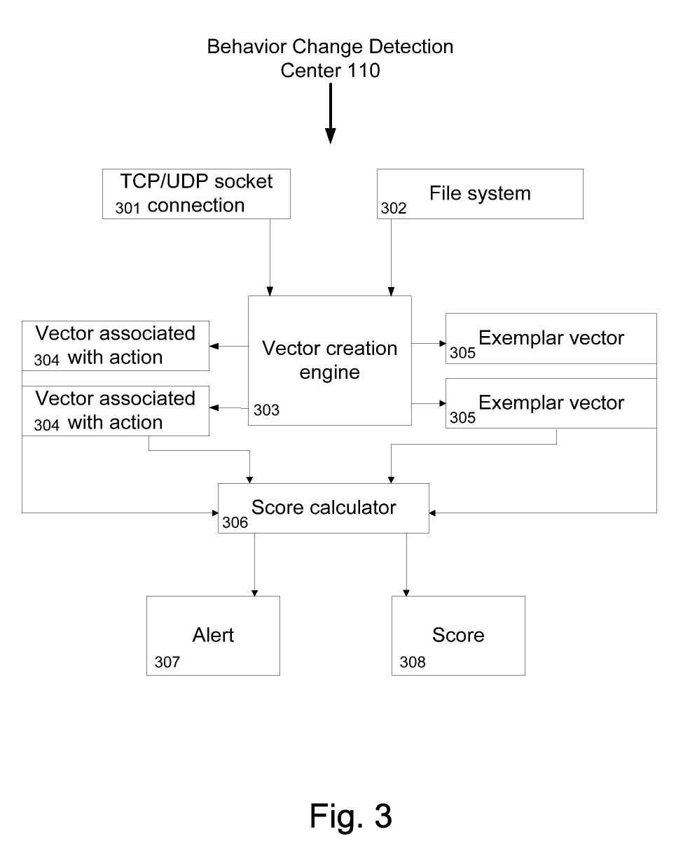

Turning now to FIG. 3, a high-level representation is provided of the behavior change detection center 110. As shown, the behavior change detection center 110 includes a networking socket connection 301. The networking socket connection 301 accepts data about each individual website action. If external data sources 120 are used, that data is received into the behavior change detection center via the file system 302. The networking connection and the file system feed their data into a vector creation engine 303. The vector creation engine transforms the data into associated vectors 304. These vectors are input into a score calculator 306, which compares the vectors with exemplar vectors 305 and computes the associated new exemplar vectors 305. In the case a score indicates an action deviates from typical website behavior, an alert 307 is generated that contains the corresponding score 308.

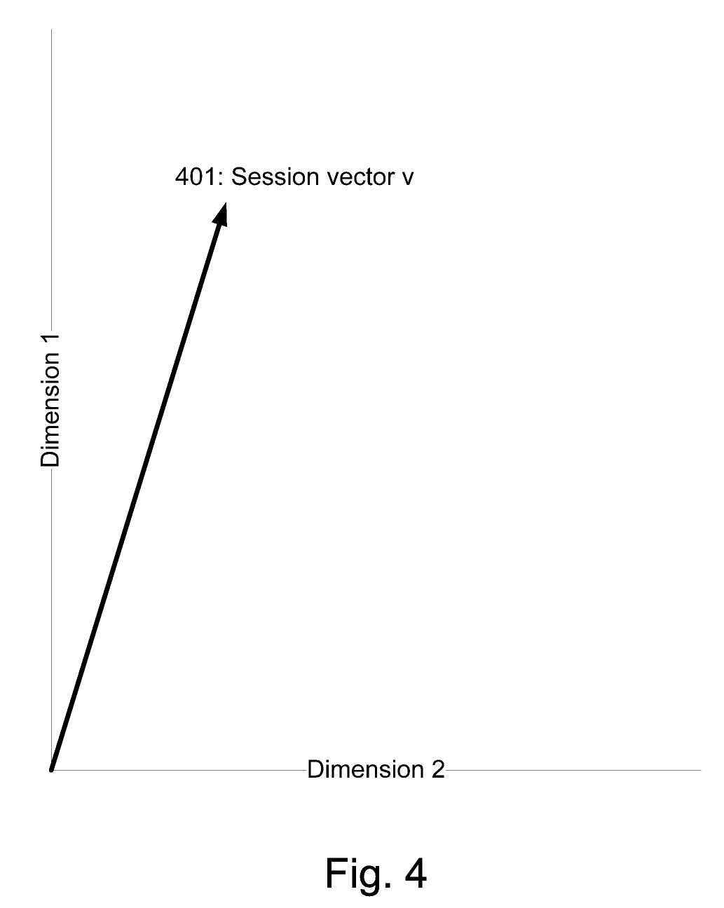

FIG. 4 shows a simplified version of mapping website session data into a vector space. The session data is parsed into multiple parameters. The parameters are mapped into n-dimensional vectors where n is the number of parameters available about the action on the website. Each vector is mapped into the n-dimensional space associated with the dimensions of the actions on the website. Non-numeric parameters are mapped to numeric values via a lookup table. For purposes of illustration, the diagram in FIG. 4 shows an n-dimensional vector v mapped into a two dimensional vector space 401.

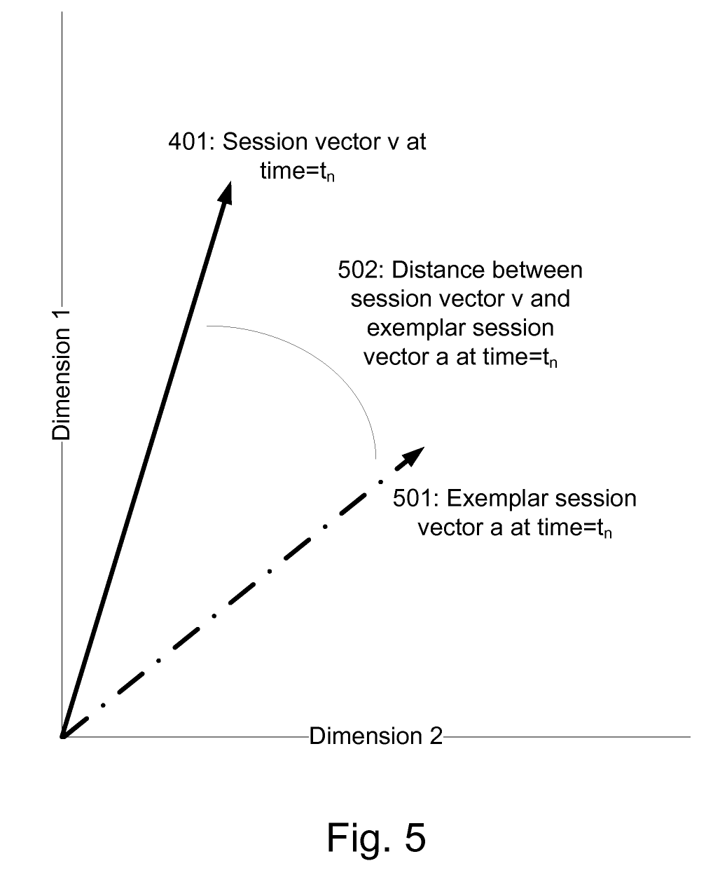

FIG. 5 illustrates the distance between a particular session vector v 401 and the exemplar vector for a similar session 501. Again, in this figure, the vectors are shown in two dimensions. However, it can be appreciated that actual vectors spaces for this dimension consist of hundreds of dimensions.

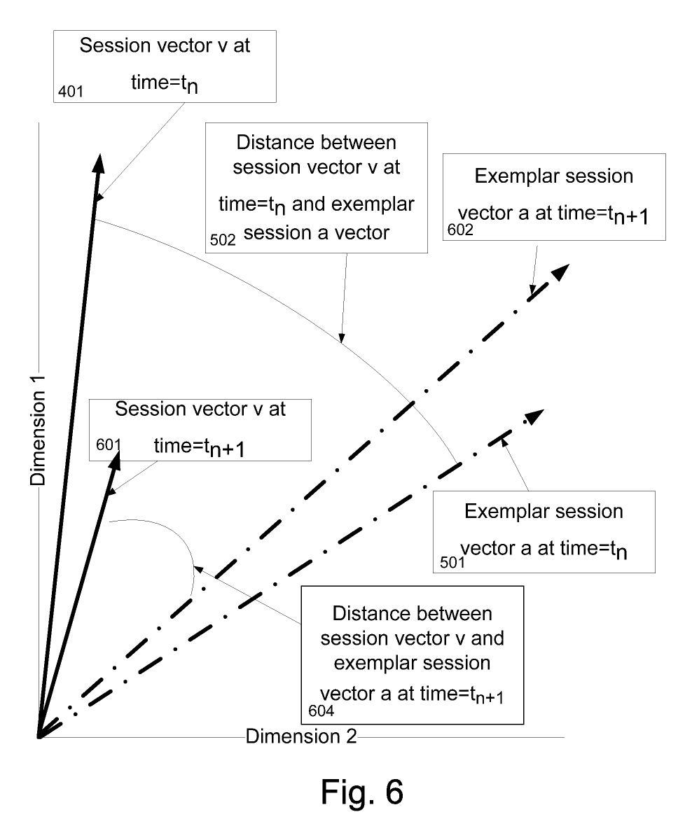

FIG. 6 shows the distance between a particular session vector v at time tₙ 401 (i.e., a first time increment) and the exemplar session vector a at time tₙ 502. In addition, FIG. 6 shows the distance between the session vector v at time tₙ₊₁ 601 (i.e., a second time increment) and the exemplar vector a at time tₙ₊₁ 602. Using the distance between v and a at time tₙ and comparing it with the distance between v and a at time tₙ₊₁ it is possible to compute the direction of movement (or travel) of v relative to a as well as the exemplar velocity of movement (or travel) of the vector between time tₙ and time tₙ₊₁. It can be appreciated that in accordance with an exemplary embodiment, an exemplar velocity of movement of the session vector can be computed within multiple time increments. In addition, a score can be generated indicative of a similarity between the session vector and the exemplar vector in a same or a similar vector space based on the exemplar velocity of movement of the session vector within the multiple time increments.

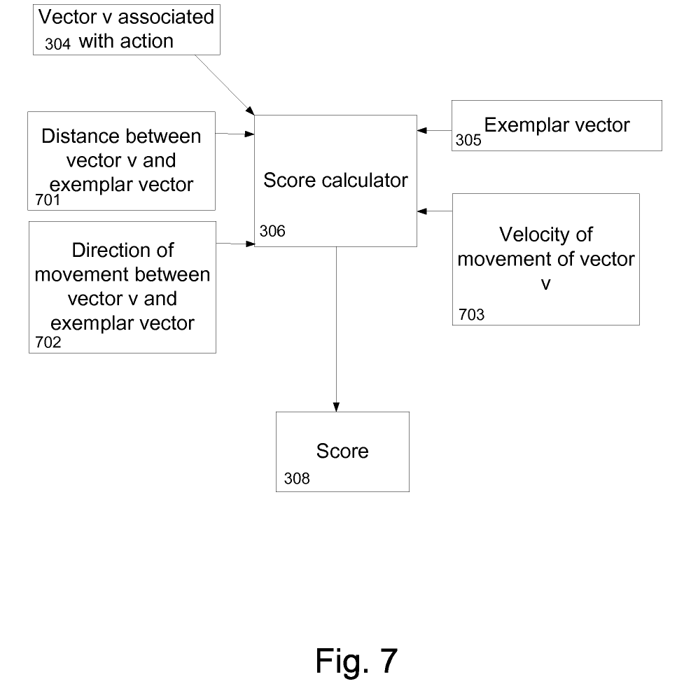

FIG. 7 gives details on a score calculator 306. As shown in FIG. 7, the score calculator 306 takes as input the current vector v associated with an action 304, the distance between v and the exemplar vector a 701, the direction of movement of v relative to a 702, and the velocity of movement of the vector v 703. These values are combined to create a score 308 that determines the likelihood that the current session is a previously unknown behavior.

In an exemplary embodiment, a computer program which implements all or parts of the processing described herein through the use of a system and/or methodology as illustrated in FIGS. 1-7 can take the form of a computer program product residing on a computer usable or computer readable medium. Such a computer program can be an entire application to perform all of the tasks necessary to carry out the processes and/or methodologies, or it can be a macro or plug-in which works with an existing general-purpose application such as a spreadsheet program. Note that the “medium” may also be a stream of information being retrieved when a processing platform or execution system downloads the computer program instructions through the Internet or any other type of network. Computer program instructions, which implement the invention, can reside on or in any medium that can contain, store, communicate, propagate or transport the program for use by or in connection with any instruction execution system, apparatus, or device. Such a medium may be, for example, but is not limited to, an electronic, magnetic, optical, electromagnetic, or semiconductor system, apparatus, device, or network. Note that the computer usable or computer readable medium could even be paper or another suitable medium upon which the program is printed, as the program can then be electronically captured from the paper and then compiled, interpreted, or otherwise processed in a suitable manner.

It will be understood that the foregoing description is of the preferred embodiments, and is, therefore, merely representative of the article and methods of manufacturing the same. It can be appreciated that many variations and modifications of the different embodiments in light of the above teachings will be readily apparent to those skilled in the art. Accordingly, the exemplary embodiments, as well as alternative embodiments, may be made without departing from the spirit and scope of the articles and methods as set forth in the attached claims

What is claimed is:

1. A method for determining a likelihood of a previously unknown use of a website using a computer system that processes data from a website session into a plurality of parameters configured to represent website session information, and wherein the parameters are combined into a vector in a vector space, the method comprising:
mapping the vector into various vector spaces;
modifying the vector as new information about each session is obtained;
comparing a change in position of the vector in the various vector spaces to determine the direction in which the vector is moving with respect to an exemplar vector in a same or a similar vector space;
generating a score indicative of the similarity between the vector and the exemplar vector in the same or the similar vector space; and
returning the score to an investigation system for analysis.

2. The method of claim 1, wherein the investigation system for analysis is human analysis of the score.

3. The method of claim 1, further comprising analyzing a change in velocity of the vector relative to the exemplar vector in the same or the similar vector space to determine if the change in velocity of the vector is indicative of previously unknown website behavior.

4. A method for determining a likelihood of a previously unknown use of a website associated with a website session, comprising:
receiving a plurality of parameters associated with an action performed during a website session;
creating a session vector that has a dimension corresponding to each of the plurality of parameters associated with the action performed during the website session;
modifying the session vector as new information about each website session is obtained; and
comparing a change in position of the session vector in various vector spaces to determine the direction in which the session vector is moving with respect to an exemplar vector in a same or a similar vector space.

5. The method of claim 4, further comprising generating a score indicative of a similarity between the session vector and the exemplar vector in the same or similar vector space based on the change in position in which the session vector is moving with respect to the exemplar vector in the various vector spaces.

6. The method of claim 5, further comprising returning the score to an investigation system for human analysis.

7. The method of claim 4, wherein the step of modifying the session vector as new information about each website session is obtained comprises:
receiving updated parameters associated with actions taken on the website session of interest; and
generating a new session vector in the vector space based on the updated parameters.

8. The method of claim 7, further comprising taking action upon detecting that the new session vector has deviated from an expected threshold to indicate new behavior.

9. The method of claim 4, further comprising:
computing a direction of movement of the session vector relative to the exemplar vector; and
generating a score indicative of a similarity between the session vector and the exemplar vector in a same or a similar vector space based on the direction of movement of the session vector relative to the exemplar vector.

10. The method of claim 4, further comprising:
computing an average velocity of movement of the session vector within multiple time increments; and
generating a score indicative of a similarity between the session vector and the exemplar vector in a same or a similar vector space based on the average velocity of movement of the session vector within the multiple time increments.

11. The method of claim 4, further comprising:
calculating a velocity of movement of the session vector and the exemplar vector; and
generating a score indicative of a similarity between the session vector and the exemplar vector in a same or a similar vector space based on the velocity of movement of the session vector and the exemplar vector.

12. The method of claim 4, further comprising:
calculating a distance between the session vector and the exemplar vector;
calculating a direction of movement of the session vector and the exemplar vector;
calculating a velocity of movement of the session vector and the exemplar vector; and
combining the distance, the direction of movement and the velocity of movement of the session vector and the exemplar vector to create a score that determines the likelihood that the current session is a previously unknown behavior.

13. The method of claim 4, further comprising using historical vectors to determine the exemplar vector for the website session.

14. A method of mapping website session data into a vector space comprising:
parsing session data into a plurality of parameters;
mapping the parameters into n-dimensional vectors, wherein n is the number of parameters available about the action on the website, and wherein each vector is mapped into the n-dimensional space associated with the dimensions of the actions on the website; and
comparing a change in position of each of the n-dimension vectors in various vector spaces to determine the direction in which each of the n-dimensional vectors is moving with respect to an exemplar vector in the various vector spaces.

15. The method of claim 14, further comprising generating a score indicative of a similarity between the n-dimensional vectors and the exemplar vector in a same or a similar vector space by calculating the direction in which the n-dimensional vectors are moving with respect to the exemplar vector.

16. A behavior change detection system comprising:
a website data center, which receives input parameters associated with website actions; and
a behavior change detection center configured to detect behavior changes by users of a website based on:
receiving a plurality of parameters associated with an action performed during a website session;
creating a session vector that has a dimension corresponding to each of the plurality of parameters associated with the action performed during the website session;
modifying the session vector as new information about each website session is obtained; and
comparing a change in position of the session vector in various vector spaces to determine the direction in which the session vector is moving with respect to an exemplar vector in a same or a similar vector space.

17. The system of claim 16, wherein the website data center provides notification in response to any detected behavior changes.

18. The system of claim 16, wherein the behavior change detection center determines whether or not a website action constitutes a behavior change on a website in substantially real-time.

19. The system of claim 18, wherein the session vectors, their velocities and the plurality of input parameters are fed into a score calculator, which compares the session vectors with the exemplar vectors, and upon the score calculator indicating that an action deviates from typical website behavior, an alert is generated that contains a corresponding score.

20. A computer readable medium containing a computer program for determining a likelihood of a previously unknown use of a website associated with a website session, wherein the computer program comprises executable instructions for:
receiving a plurality of parameters associated with an action performed during a website session;
creating a session vector that has a dimension corresponding to each of the plurality of parameters associated with the action performed during the website session;
modifying the session vector as new information about each website session is obtained; and
comparing a change in position of the session vector in various vector spaces to determine the direction in which the session vector is moving with respect to an exemplar vector in a same or a similar vector space.
